(19) United States
(12) Patent Application Publication
(10) Pub. No.: US 2007/0294897 A1
(43) Pub. Date: Dec. 27, 2007

(54) SCISSORS THAT CAN SHRED PAPER EASILY AND QUICKLY

(76) Inventor: Yi-Hung Chen, Changhua City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/745,598

(22) Filed: May 8, 2007

(30) Foreign Application Priority Data
Jun. 26, 2006 (TW) 095211143

(51) Int. Cl. B26B 13/00

(52) U.S. Cl. 30/254

(57) ABSTRACT

A pair of scissors include a pair of intersecting main cutting members pivotally connected with each other, and multiple pairs of intersecting secondary cutting members pivotally connected with each other and coupled with the main cutting members so that each pair of the intersecting secondary cutting members are movable in concert with the main cutting members to perform opening or closing actions. Thus, the secondary cutting members co-operate with the main cutting members to form multiple cutting slits on the paper at a time so as to shred the paper or cut the paper into multiple pieces in a shorter period of time, thereby saving the working time and enhancing the working efficiency.

### BACKGROUND OF THE INVENTION

1. Field of the Invention

The present invention relates to a cutting tool and, more particularly, to a pair of scissors for cutting or shredding paper.

2. Description of the Related Art

A pair of conventional scissors comprise two cutting members pivotally connected with each other by a pivot pin. Each of the cutting members has a front end provided with a cutting blade, a mediate portion formed with a pivot hole pivotally mounted on the pivot pin and a rear end provided with a grip. Thus, the cutting members are pivotable relative to each other to drive the cutting blades to move relative to each other to perform a cutting action so as to cut a sheet of paper or to form a cutting slit on the paper.

However, the conventional scissors cannot shred the paper so that when a user needs to cut the paper into multiple pieces for art designing purposes, he/she needs to cut the paper many times so as to cut the paper into multiple pieces, thereby wasting the working time and decreasing the working efficiency. In addition, the user needs to hold the grips to open and close the scissors many times so as to cut the paper into multiple pieces, so that the user's hand easily feels tired or painful due to frequent operations of the scissors.

### BRIEF SUMMARY OF THE INVENTION

In accordance with the present invention, there is provided a pair of scissors, comprising a pair of intersecting main cutting members pivotally connected with each other, and multiple pairs of intersecting secondary cutting members pivotally connected with each other and coupled with the main cutting members so that each pair of the intersecting secondary cutting members are movable in concert with the main cutting members to perform opening or closing actions.

The primary objective of the present invention is to provide a pair of scissors that can shred paper easily and quickly to decrease the operation times of the scissors.

Another objective of the present invention is to provide a pair of scissors, wherein the secondary cutting members co-operate with the main cutting members to form multiple cutting slits on the paper at a time so as to shred the paper or cut the paper into multiple pieces in a shorter period of time, thereby saving the working time and enhancing the working efficiency.

A further objective of the present invention is to provide a pair of scissors, wherein the secondary cutting members co-operate with the main cutting members to form multiple cutting slits on the paper at a time so that the closing and opening actions of the scissors are reduced largely, thereby preventing the user's hand from feeling tired or painful due to frequent operations of the scissors.

A further objective of the present invention is to provide a pair of scissors, wherein the spacers have different thicknesses to change the distances between the main cutting members and the secondary cutting members to form cutting slits of different widths on the paper, thereby enhancing the aesthetic quality of the paper.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a pair of scissors in accordance with the preferred embodiment of the present invention.

FIG. 2 is a partially exploded perspective view of the scissors as shown in FIG. 1.

FIG. 3 is a schematic operational view of the scissors as shown in FIG. 1.

FIG. 4 is a schematic operational view of the scissors as shown in FIG. 3.

### DETAILED DESCRIPTION OF THE INVENTION

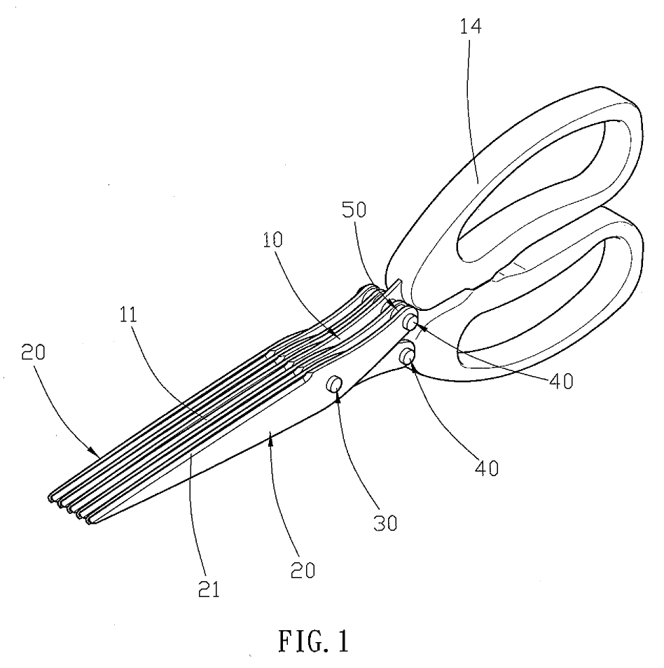

Referring to the drawings and initially to FIGS. 1-3, a pair of scissors in accordance with the preferred embodiment of the present invention comprise a pair of intersecting main cutting members 10 pivotally connected with each other, and multiple pairs of intersecting secondary cutting members 20 pivotally connected with each other and coupled with the main cutting members 10 so that each pair of the intersecting secondary cutting members 20 are movable in concert with the main cutting members 10 to perform opening or closing actions.

The main cutting members 10 are pivotally connected with each other by a pivot pin 30. The pivot pin 30 extends through and protrudes outwardly from the two main cutting members 10. Each of the main cutting members 10 has a first end formed with a main blade portion 11 and a second end provided with a fixing pin 40 and a grip portion 14 located beside the fixing pin 40. The second end of each of the main cutting members 10 is formed with a fixing hole 13 fixed on the fixing pin 40, and the fixing pin 40 extends through and protrudes outwardly from two opposite side of each of the main cutting members 10. The pivot pin 30 is located between the main blade portion 11 and the fixing pin 40 of each of the main cutting members 10, and each of the main cutting members 10 has a mediate portion formed with a pivot hole 12 pivotally mounted on the pivot pin 30 and located between the main blade portion 11 and the fixing hole 13.

The secondary cutting members 20 are juxtaposed to the main cutting members 10. Each pair of the intersecting secondary cutting members 20 are pivotally connected with each other by the pivot pin 30. The pivot pin 30 extends through and protrudes outwardly from the secondary cutting members 20. Each of the secondary cutting members 20 has a first end formed with a secondary blade portion 21 and a second end formed with a fixing bore 23 fixed on the fixing pin 40 of a respective main cutting member 10. Each pair of the intersecting secondary cutting members 20 are pivotable relative to each other when the main cutting members 10 are pivotable relative to each other, so that the secondary blade portions 21 of each pair of the intersecting secondary cutting members 20 are movable in concert with the main blade portions 11 of the main cutting members 10 when the main cutting members 10 are pivotable relative to each other.

The fixing pin 40 of each of the main cutting members 10 extends through and protrudes outwardly from the respective secondary cutting members 20. The pivot pin 30 is located between the secondary blade portion 21 of each of the secondary cutting members 20 and the fixing pin 40 of the respective main cutting member 10, and each of the secondary cutting members 20 has a mediate portion formed with a pivot bore 22 pivotally is mounted on the pivot pin 30 and located between the secondary blade portion 21 and the fixing bore 23.

The secondary cutting members 20 are separated from each other by a plurality of spacers 50, while the secondary cutting members 20 are also separated from the main cutting members 10 by the spacers 50 to prevent the secondary cutting members 20 from interfering with each other and to prevent the secondary cutting members 20 from interfering with the main cutting members 10. The spacers 50 are mounted on the pivot pin 30 and the fixing pins 40. Preferably, the spacers 50 have different thicknesses to change the distances between the main cutting members 10 and the secondary cutting members 20 to form cutting slits of different widths on a sheet of paper.

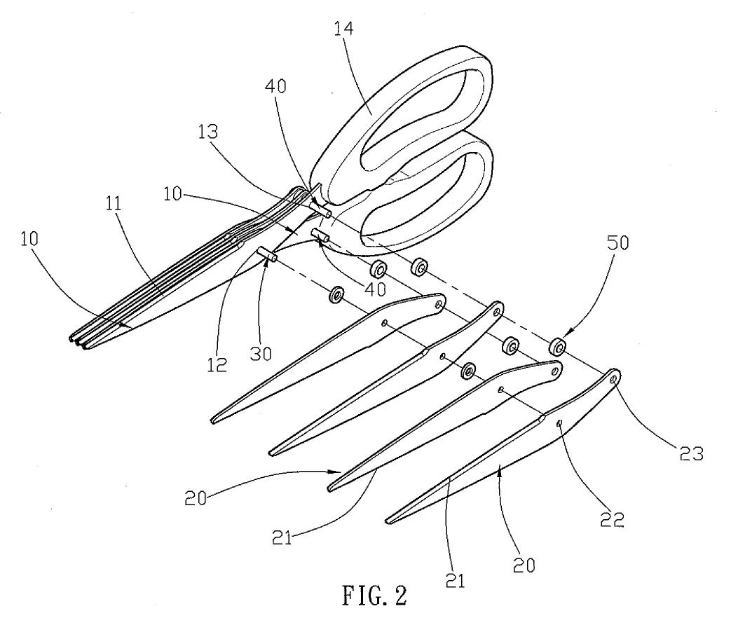

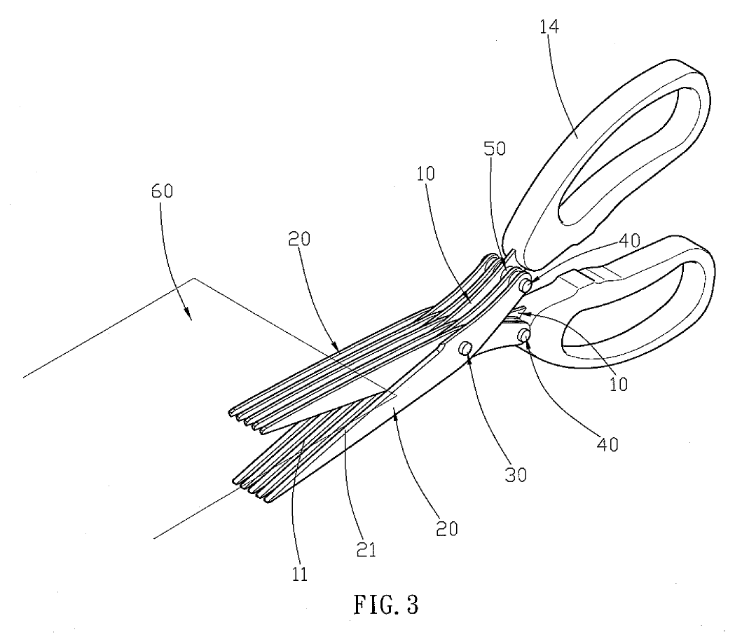

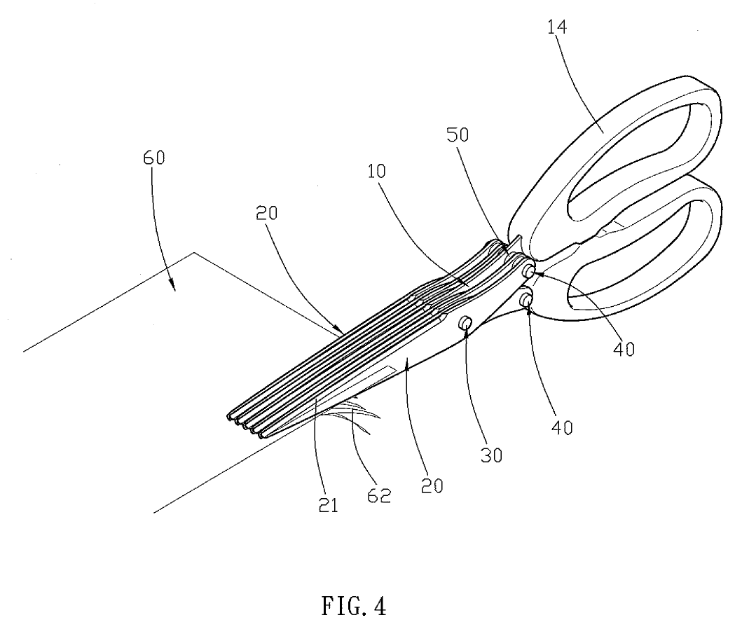

In operation, referring to FIGS. 3 and 4 with reference to FIGS. 1 and 2, each pair of the intersecting secondary cutting members 20 are pivotable relative to each other when the main cutting members 10 are pivotable relative to each other, so that the secondary blade portions 21 of each pair of the intersecting secondary cutting members 20 are movable in concert with the main blade portions 11 of the main cutting members 10 when the main cutting members 10 are pivotable relative to each other.

In such a manner, the secondary cutting members 20 and the main cutting members 10 are opened or closed simultaneously as shown in FIGS. 3 and 4 to cut a sheet of paper 60 by the secondary blade portions 21 of the secondary cutting members 20 and the main blade portions 11 of the main cutting members 10 so as to form multiple cutting slits 62 on the paper 60 at a time so that the secondary cutting members 20 co-operate with the main cutting members 10 to shred the paper 60 in a shorter period of time. Thus, the scissors are used to shred the paper 60 to destroy an important information or to cut the paper 60 into multiple pieces for art designing purposes.

Accordingly, the secondary cutting members 20 co-operate with the main cutting members 10 to form multiple cutting slits 62 on the paper 60 at a time so as to shred the paper 60 or cut the paper 60 into multiple pieces in a shorter period of time, thereby saving the working time and enhancing the working efficiency. In addition, the secondary cutting members 20 co-operate with the main cutting members 10 to form multiple cutting slits 62 on the paper 60 at a time so that the closing and opening actions of the scissors are reduced largely, thereby preventing the user's hand from feeling tired or painful due to frequent operations of the scissors. Further, the spacers 50 have different thicknesses to change the distances between the main cutting members 10 and the secondary cutting members 20 to form cutting slits 62 of different widths on the paper, thereby enhancing the aesthetic quality of the paper.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A pair of scissors, comprising:
a pair of intersecting main cutting members pivotally connected with each other;
multiple pairs of intersecting secondary cutting members pivotally connected with each other and coupled with the main cutting members so that each pair of the intersecting secondary cutting members are movable in concert with the main cutting members to perform opening or closing actions.

2. The scissors in accordance with claim 1, wherein the main cutting members are pivotally connected with each other by a pivot pin.

3. The scissors in accordance with claim 2, wherein the pivot pin extends through and protrudes outwardly from the two main cutting members.

4. The scissors in accordance with claim 2, wherein each of the main cutting members has a first end formed with a main blade portion and a second end provided with a fixing pin.

5. The scissors in accordance with claim 4, wherein the second end of each of the main cutting members is provided with a grip portion located beside the fixing pin.

6. The scissors in accordance with claim 4, wherein the second end of each of the main cutting members is formed with a fixing hole fixed on the fixing pin.

7. The scissors in accordance with claim 4, wherein the fixing pin extends through and protrudes outwardly from two opposite side of each of the main cutting members.

8. The scissors in accordance with claim 4, wherein the pivot pin is located between the main blade portion and the fixing pin of each of the main cutting members.

9. The scissors in accordance with claim 4, wherein each of the main cutting members has a mediate portion formed with a pivot hole pivotally mounted on the pivot pin and located between the main blade portion and the fixing hole.

10. The scissors in accordance with claim 4, wherein each pair of the intersecting secondary cutting members are pivotally connected with each other by the pivot pin.

11. The scissors in accordance with claim 10, wherein the pivot pin extends through and protrudes outwardly from the secondary cutting members.

12. The scissors in accordance with claim 10, wherein each of the secondary cutting members has a first end formed with a secondary blade portion and a second end formed with a fixing bore fixed on the fixing pin of a respective main cutting member.

13. The scissors in accordance with claim 12, wherein each pair of the intersecting secondary cutting members are pivotable relative to each other when the main cutting members are pivotable relative to each other, so that the secondary blade portions of each pair of the intersecting secondary cutting members are movable in concert with the main blade portions of the main cutting members when the main cutting members are pivotable relative to each other.

14. The scissors in accordance with claim 12, wherein the fixing pin of each of the main cutting members extends through and protrudes outwardly from the respective secondary cutting members.

15. The scissors in accordance with claim 12, wherein the pivot pin is located between the secondary blade portion of each of the secondary cutting members and the fixing pin of the respective main cutting member.

16. The scissors in accordance with claim 12, wherein each of the secondary cutting members has a mediate portion formed with a pivot bore pivotally mounted on the pivot pin and located between the secondary blade portion and the fixing bore.

17. The scissors in accordance with claim 12, wherein the secondary cutting members are separated from each other by a plurality of spacers, and the secondary cutting members are separated from the main cutting members by the spacers to prevent the secondary cutting members from interfering with each other and to prevent the secondary cutting members from interfering with the main cutting members.

18. The scissors in accordance with claim 17, wherein the spacers are mounted on the pivot pin and the fixing pins.

19. The scissors in accordance with claim 71, wherein the spacers have different thicknesses to change distances between the main cutting members and the secondary cutting members.

20. The scissors in accordance with claim 1, wherein the secondary cutting members are juxtaposed to the main cutting members.
